(19) United States
(12) Patent Application Publication
(10) Pub. No.: US 2006/0224092 A1
(43) Pub. Date: Oct. 5, 2006

(54) Massaging apparatus

(76) Inventor: Shang-Wei Chou, Taipei (TW)

Correspondence Address: PRO-TECTOR INTERNATIONAL SERVICES, 20775 NORADA CT., SARATOGA, CA, 95070, US

(21) Appl. No.: 11/098,836

(22) Filed: Apr. 4, 2005

(51) Int. Cl. A61H 7/00

(52) U.S. Cl. 601/133; 601/84; 601/112

(57) ABSTRACT

A massaging apparatus comprises a main body; a roll inside the main body from which several studs radially extend outwards; a driving device in the main body, driving the roll in a rotating movement; and a projection, mounted on the main body at a position to which ends of the studs move during the rotating movement; wherein, after placing the main body on a user's skin, the rotating movement causes the ends of the studs to shove tissue below the user's skin against the projection, having a massaging effect like repeatedly squeezing and releasing the tissue with fingers.

### BACKGROUND OF THE INVENTION

1. Field of the Invention

The present invention relates to a massaging apparatus, particularly to a massaging apparatus which simulates a finger-clamping movement for easing tense muscle tissue.

2. Description of Related Art

Muscle tissue is placed between the skin and muscles of the human body and contains ligaments for transmitting force of contracting muscles. Due to today's hectic pace of life combined with little exercise, people regularly suffer from pain in the hips, neck and head, which are often caused by inflammation of muscle tissue, but wrongly attributed other causes. If, however, muscle tissue is massaged daily, prevention is taken and occurrences of pain as well as inflammations are diminished.

Moreover, since ligaments extend from muscles to bones and joints, muscle tissue pain is often wrongly diagnosed as a disease of bones and joints, like a pophysis or arthritis.

The symptoms just discussed are prevented or relieved by massages. Since, while living with a busy schedule, massaging at any given time by a profeesional masseur is difficult, massaging apparatuses have to be relied on for performing massages. Effective massaging requires clamping movements on muscle and surface tissue and rubbing of surface tissue. Massaging apparatuses that are available on the market, however, generate only local pressure variations by vibrations, which is not effective for muscle tissue.

### SUMMARY OF THE INVENTION

It is the object of the present invention to provide a massaging apparatus which simulates clamping finger movements for effective massaging.

The massaging apparatus of the present invention has a roll inside a main body from which several studs with rounded ends radially extend outwards, performing a rotating movement driven by a driving device, and a projection, mounted on the main body at a position to which ends of the studs move during the rotating movement, so that the rotating movement causes the ends of the studs to shove tissue below the user's skin against the projection, having a massaging effect like repeatedly squeezing and releasing the tissue with fingers.

The present invention can be more fully understood by reference to the following description and accompanying drawings.

### DETAILED DESCRIPTION OF THE PREFERRED EMBODIMENT

The massaging apparatus of the present invention comprises a main body 10; a roll 20; a driving device 30; a contact element 40; a projection 50; and a pressing rod 60. A detailed explanation is given in the following.

The main body 10 is shaped like a bowl, allowing to be easily gripped by a hand of a user. A chamber 11 is placed inside the main body 10, having an upper side with a base surface 12 into which an elongated opening 13 is cut.

As shown in FIG. 11, the main body has a left faceplate 14, a right faceplate 16 and an upper faceplate 18. The left and right faceplates 14, 16 have corresponding hooks and openings, furthermore elongated holes 15, 17 into which ribs 19 on the upper faceplate 18 are laid for assembling the main body 10.

The roll 20 is placed inside the chamber 11. An axial hole 21 is bored into the roll 20. Several studs 22 extend radially from the roll 20. As shown in FIG. 1, the studs 22 project partly out of the base surface 12 through the elongated opening 13. Thus, as shown in FIGS. 3-5, when the user brings the base surface 12 close to her or his skin, the studs 22 come into contact therewith.

The driving device 30 is placed inside the chamber 11, having an axis 31 that is inserted into the axial hole 21 of the roll 20. As shown in FIG. 2, the driving device 30 has two synchronous motors arranged symmetrically to opposite sides of the roll 20, so that production costs are kept low. Alternatively, a single motor with gears is used. The axial hole 21 of the role 20 is connected with the axis 31 of the driving device 30, so that the roll 20 is driven in a rotating movement. The two motors of the driving device 30 are respectively mounted on the left and right faceplates 14, 16. Alternatively, a single motor is employed. Further modifications are possible within the range of the present invention.

Referring to FIG. 1, the driving device 30 is connected via a power cable 32 with an electric power source, which is a power outlet or another power source. According to demand, a switch 33 or a switching device 34 are added.

The contact element 40 is mounted on the base surface 12 of the main body 10, having a projection 50 on a front end with respect to the rotating movement of the roll 20. Thus during the rotating movement thereof, a clamping movement of the studs 22 against the projection 50 is generated, similar to a pincer movement of fingers. As shown in FIGS. 3-5, when the user slightly presses the base surface 12 of the main body 10 on her or his skin, the projection 50 depresses tissue below the skin, while the studs 22 press thereon, as well.

Referring again to FIGS. 4 and 5, when the roll performs the rotating movement, muscle tissue of the user is shoved towards the projection 50 in a movement similar to fingers repeatedly clamping and releasing muscle tissue, so that a massaging effect is achieved.

The studs 22 on the roll 20 have rounded ends, thereby generating gentle pressure on tissue, and project from the base surface 12 to a lesser degree than the projection 50. According to experiments, having the base surface 12 project about one half as far as the projection 50 leads to a smooth, unblocked squeezing movement.

The projection 50 has a length that is adaptable to the user. The contact element 40 and the attached projection 50 are easily replaceable for optimum effect.

As shown in FIGS. 1-5, the base plate 12 further has elongated holes 121, and the contact element 40 has on a lower side a fastening element 41 for fixing on the elongated opening 13, so that the contact element 40 will not fall down.

Referring to FIGS. 6 and 7, the present invention allows for usage of various projections 50a, 50b and contact elements 40a, 40b, which are easily replaceable according to demand. Alternatively, the projection 50 is directly mounted on the main body 10.

Referring to FIGS. 8-11, the present invention in a second embodiment further has a pressing rod 60, shaped like the letter U, reaching over the base plate 12 and having two ends 61 that are connected with the main body 10. The pressing rod 60 serves to smoothen clothes next to a spot to be massaged to avoid interference of clothes with massaging.

Referring to FIGS. 9-11, the pressing rod has an elastic mechanism 70 having a spring assembly 71 and a pin 72. The spring assembly 71 further has a fixed end 73 which is inserted into a fixing hole 75 on the main body 10, a moved end 75 and a rib 77 thereon. The pin 72 has narrow ends 74 which respectively pass through the left and right faceplates 14, 16 and are connected with the ends 61 of the pressing rod 60. The pin 72 further has a middle section of a relatively large diameter into which a longitudinal groove is cut that engages with the rib 77 on the moved end 75 of the spring assembly 71. Thereby, rotating the pin 72 is attenuated by the spring assembly 71.

### BRIEF DESCRIPTION OF THE DRAWINGS

FIG. 1 is a perspective view of the massaging apparatus of the present invention.

FIG. 2 is an exploded perspective view of the massaging apparatus of the present invention.

FIGS. 3-5 are schematic illustrations of the operation of the present invention.

FIGS. 6 and 7 are schematic illustrations of the contact element and the projection of the present invention.

FIG. 8 is a perspective view of the massaging apparatus of the present invention in the second embodiment.

FIG. 9 is an exploded perspective view of the massaging apparatus of the present invention in the second embodiment.

FIG. 10 is a schematic illustration of the operation of the present invention in the second embodiment.

FIG. 11 is a schematic illustration of the present invention in the second embodiment with some structural parts removed.

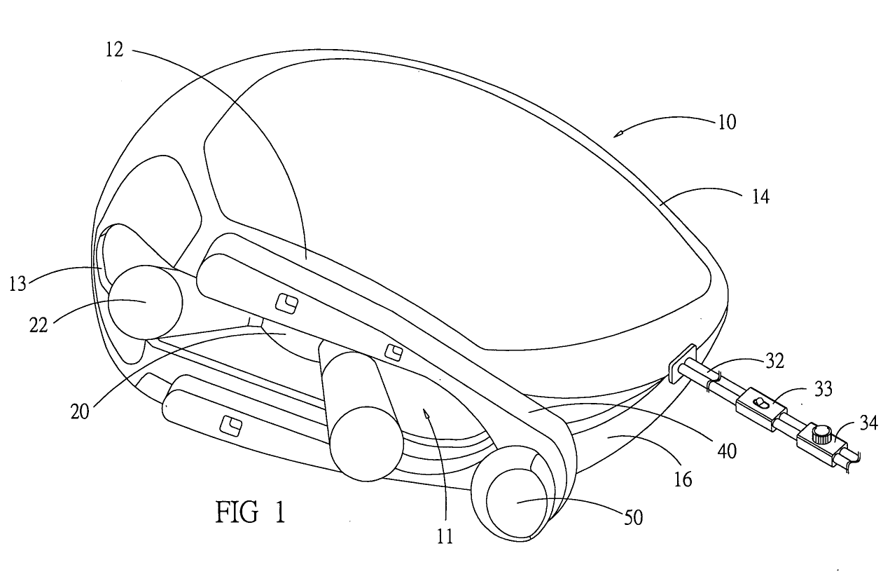

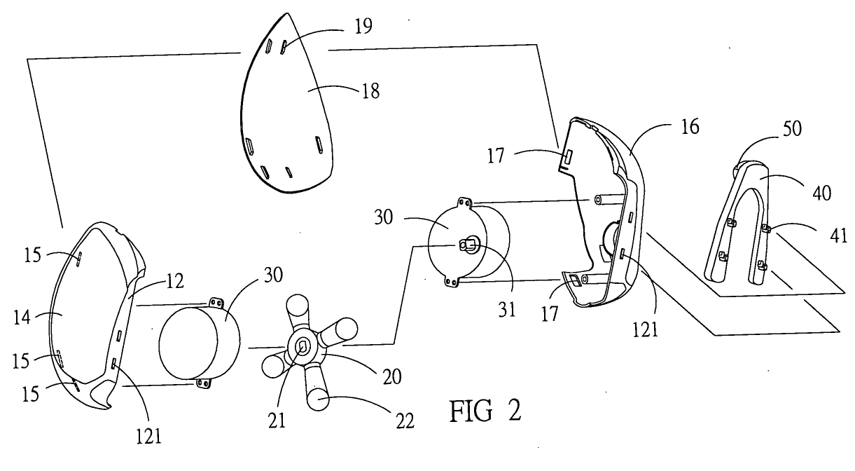

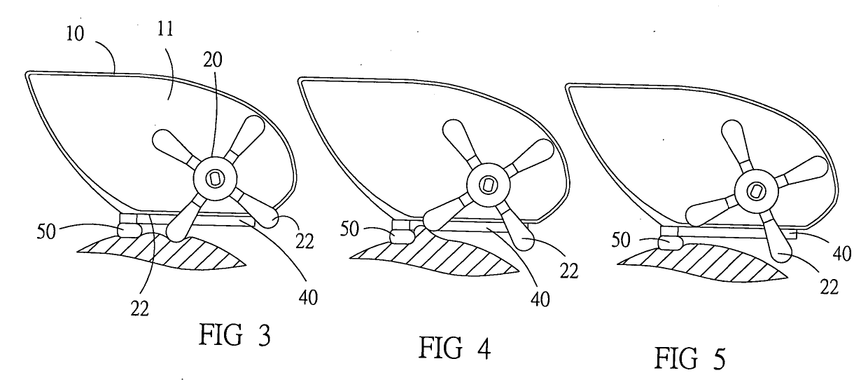

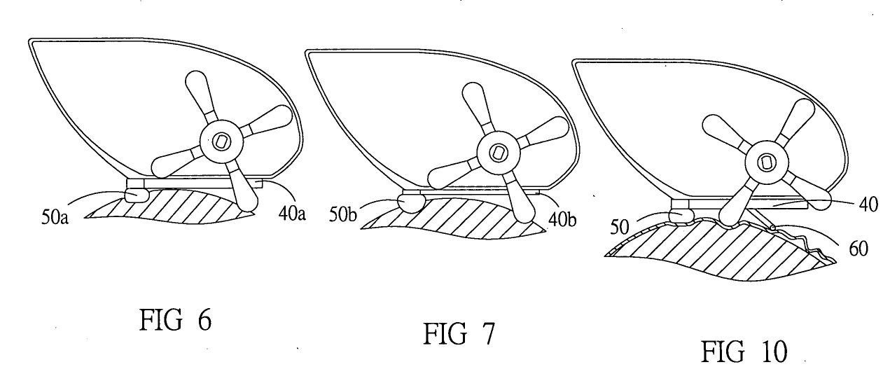

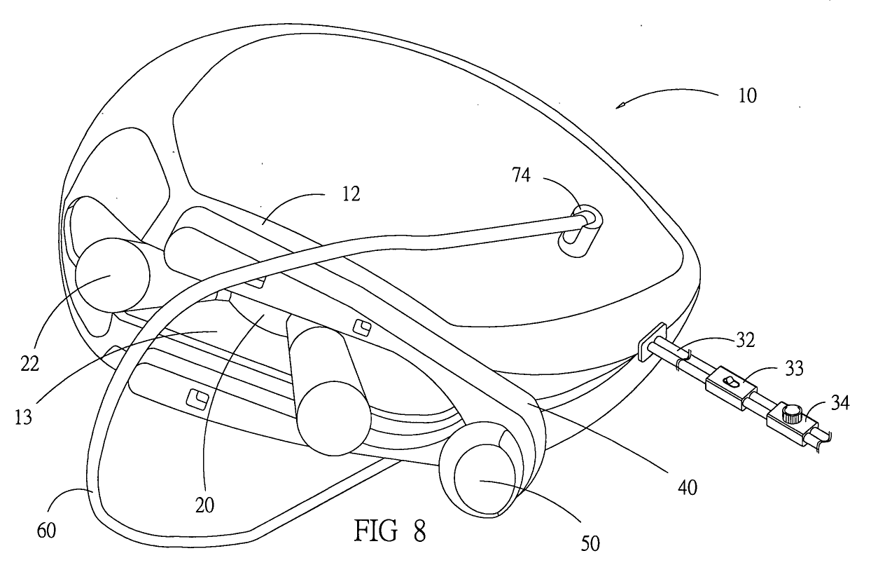

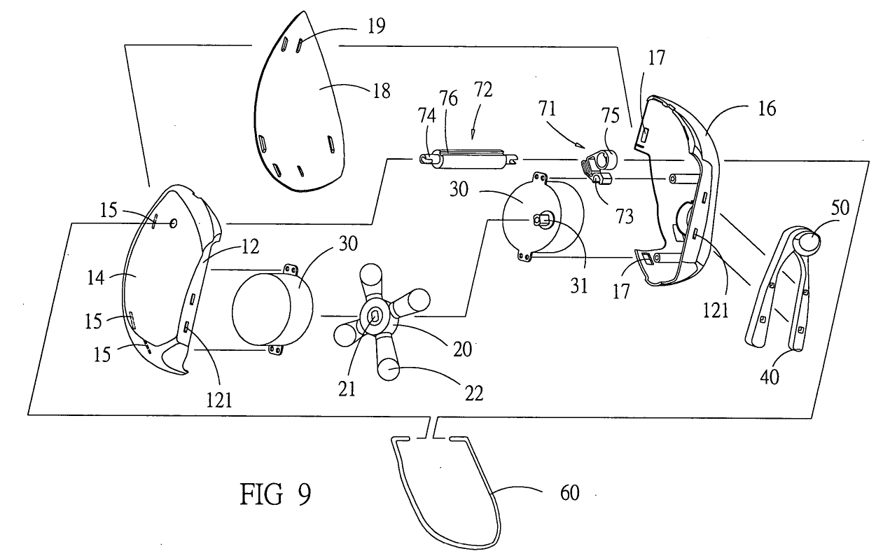

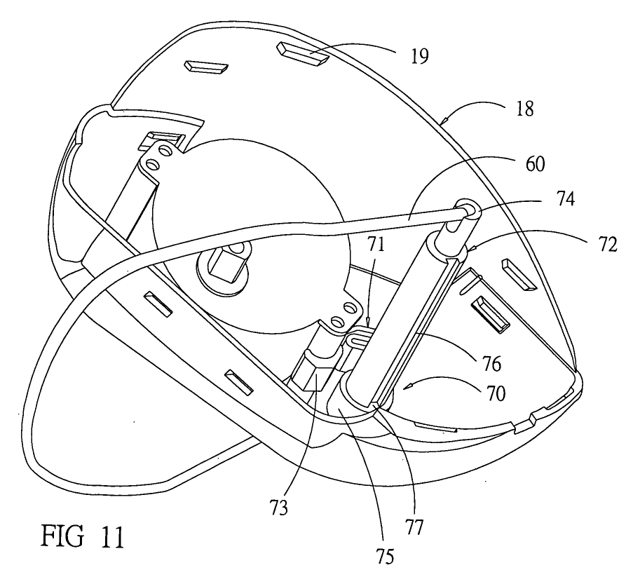

1. A massaging apparatus, comprising:
a main body, having a inner chamber;
a roll, placed in said chamber and having a periphery from which several studs radially extend outwards which have ends suitable for contacting a user's skin;
a driving device, placed in said chamber and driving said roll in a rotating movement; and
a projection, mounted on said main body at a position to which said ends of said studs move during said rotating movement;
wherein, after placing said main body on said user's skin, said rotating movement causes said ends of said studs to shove tissue below said user's skin against said projection, having a massaging effect like repeatedly squeezing and releasing said tissue with fingers.

2. The massaging apparatus according to claim 1, wherein said ends of said studs have rounded shapes.

3. The massaging apparatus according to claim 1, wherein said driving device has a synchronous motor.

4. The massaging apparatus according to claim 1, wherein said driving device has two synchronous motors.

5. The massaging apparatus according to claim 1, wherein said driving device has two synchronous motors.

6. The massaging apparatus according to claim 1, wherein said main body has a base plate to be placed close to said user's skin on which said projection is mounted and through which said ends of said studs project outwards.

7. The massaging apparatus according to claim 6, wherein a contact element carrying said projection is mounted on said base plate.

8. The massaging apparatus according to claim 1, further comprising a pressing rod for smoothening clothes on said user's skin, facilitating operation.

9. The massaging apparatus according to claim 8, wherein said pressing rod has an elastic mechanism.

10. The massaging apparatus according to claim 9, wherein said elastic mechanism comprises a spring assembly and a pin, said spring assembly having a fixed end mounted on an inner side of said main body and a rotatable driven end, said pin having narrow ends passing through faceplates of said main body and connected with ends of said pressing plate and having a middle section engaging with said driven end of said spring assembly, so that a turning movement of said pin is attenuated.
